(19) United States
(12) Patent Application Publication
(10) Pub. No.: US 2014/0253504 A1
(43) Pub. Date: Sep. 11, 2014

(54) MOBILE ELECTRONIC DEVICE WITH SENSORS

(71) Applicant: Science Ranger Corp., New York, NY (US)

(72) Inventors: Hyduke Noshadi, Sherman Oaks, CA (US); Cyrus Alexander Azima, San Francisco, CA (US)

(73) Assignee: Science Ranger Corp., New York, NY (US)

(21) Appl. No.: 14/198,459

(22) Filed: Mar. 5, 2014

Related U.S. Application Data
(60) Provisional application No. 61/773,004, filed on Mar. 5, 2013.

(51) Int. Cl. H04M 1/725; G06F 3/041

(52) U.S. Cl. CPC H04M 1/7258; G06F 3/0414
USPC 345/174

(57) ABSTRACT

The present application discloses a system comprising a mobile device and an assembly of sensors that are attached to the device and that provide added control functions of the device. The sensors may consist of flex pressure or motion sensors or essentially any sensor construct that can receive tactile input from the touch of a user. The sensors are connected to the device through input-output pins or through a proprietary wireless communication protocol. The sensors transfer user actions to provide commands to the device to operate the specific functionalities associated with the sensor data. In certain embodiments, the pressure sensors are formed in an array such that a chain of sensor inputs maps a movement by the user to an action performed by the device. With the appropriate mechanical expedients, haptic capabilities are provided such that feedback to the user is provided by pressure or vibration sensations on the device.

### CROSS-REFERENCE TO RELATED APPLICATION

This application claims priority to U.S. Provisional Application Ser. No. 61/773,004 filed Mar. 5, 2013, and is incorporated herein by reference in its entirety.

### BACKGROUND

The modern cell phone, especially the modern smart phone, has become a staple of modern life and is often the primary tool through which users place calls and otherwise interacts with their on-line environment, including shopping, social media, business relations, and other services.

Typically, the cell phone features a screen or other input device that has a variety of functions including an alpha numeric keypad and other mechanisms, such as a touch screen, that govern the basic operation of the device. Actuation of the screen, or dedicated buttons, creates commands that operate the device and can cause the device to interact with companion devices such as speakers, televisions, or video display devices. Apart from the touch screen, smart buttons, or alphanumeric pad, the input choices for a cell phone are typically limited controls, buttons, or items that perform a single dedicated function as dictated by a push button or an ordinary on/off function of the device.

For example, a dedicated smart button may drive the phone into a specific, pre-determined mode of operation, for example, to engage an internet browser or may direct the user to the display of email messages. In similar fashion, dedicated volume buttons may increase or decrease the volume of the speaker or alter the volume of a ringtone or earpiece. These buttons are simple one-function operators and respond in binary fashion to being pressed.

Accordingly, apart from the dedicated icons on a touch screen, the choices for specialized input on the body of the cell phone tend to be limited to items such as volume controls or smart buttons and offer limited ability to be custom tailored to the specific choices of the user. Also, the level and complexity of the user's discreet interactions with the device tends to be limited to buttons or keys that perform dedicated functions.

### SUMMARY

The present application discloses a system comprising a mobile electronic device and an assembly of sensors that are attached to the electronic device and that provide added control to operate or control functions of the electronic device. The sensors may consist of flex pressure or motion sensors or essentially any sensor construct that can receive tactile input from the touch of a user. Preferably, the sensors are attached to the mobile device through input-output (I/O) pins or through a proprietary wireless communication protocol. The sensors transfer user actions to provide commands to the device to operate the specific functionalities associated with the sensor data.

The mobile electronic device may be a cell phone or a device controller that is capable of receiving tactile input from a user. In certain embodiments, the pressure sensors are formed in an array such that a chain of pressure data inputs maps a movement by the user to an action performed by the electronic device. With the appropriate mechanical expedients, haptic capabilities are provided such that feedback from the device to the user is provided by pressure or vibration sensations that add an interactive or feedback element to the operation of the device.

### BRIEF DESCRIPTION OF THE DRAWINGS

FIG. 1 illustrates an illustration of one embodiment of the sensors attached to an electronic device.

FIG. 2 illustrates an exemplary illustration of sensors incorporated into a device case.

FIG. 3 illustrates an exemplary illustration of sensors incorporated into the body of a device.

FIG. 4 illustrates an exemplary illustration of an electronic array.

FIG. 5 illustrates the interface between the user, the device, and embedded software.

FIG. 6 illustrates one illustration of path registration technique.

FIG. 7 illustrates a notional embodiment of the chain matching technique.

FIG. 8 illustrates the an embodiment of chain matching technique

FIG. 9 illustrates an embodiment of an intelligent case.

FIG. 10 illustrates the top and side views of an exemplary pressure sensor array.

FIG. 11 is a further illustration of a top and side view of an exemplary pressure sensor which is not comprised of an array of sensors.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

A mobile device 102 such as a cell phone is comprised of a sensing device 104 is attached to input/output (IO) connection 106 of the device. The sensing device 104 covers at least a portion of the outer surface of the mobile device 102 and contacts to at least two edges of the device 102. For certain embodiments, the sensing device 104 is specifically oriented at the periphery of the housing of the device 102 such that a first portion of the sensing device is attached to the device's left and right side edges. Using touch of the hand and hand motion, commands are transferred from the touch of the user to the device 102 to control the device 102 by performing certain commands that can control phone function or essentially any function or application that the device 102 operates.

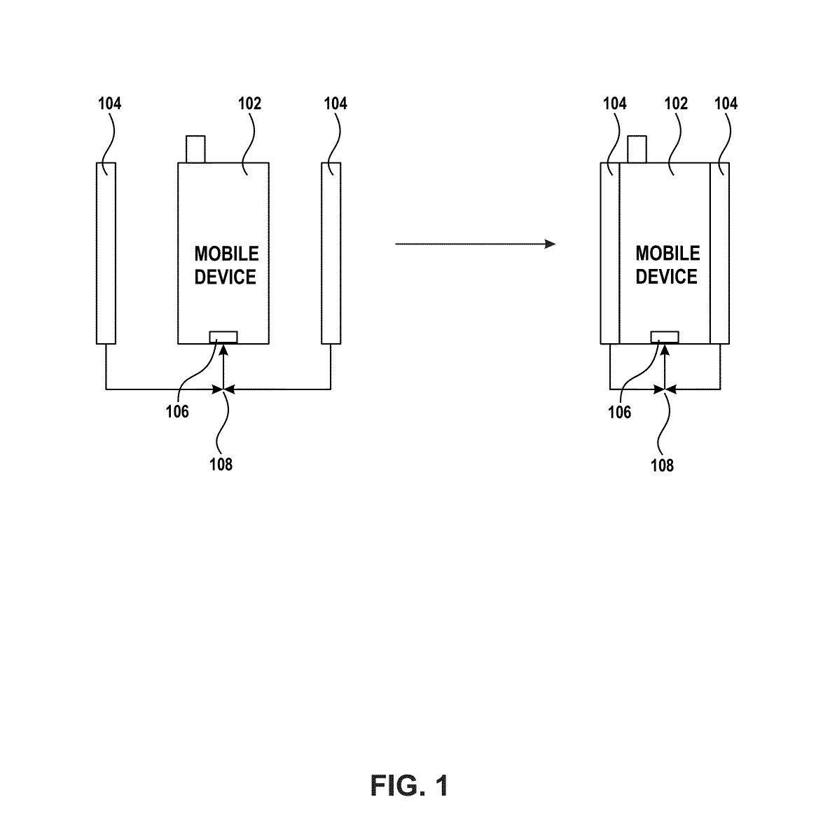

Referring to FIG. 1, the device 102 has a sensing device 104 attached to both outer, lateral edges of the device 102, and contains an electrical connection 108 that facilitates communication with the phone through the input/output connector 106. In this embodiment, the sensing device 104 covers the lateral edges of the device 102 and is affixed along substantially the entire length thereof. Each lateral portion can be independently attached to the edge of the device 102 or may be mechanically interconnected to be held in place.

### Electronic Device Cover

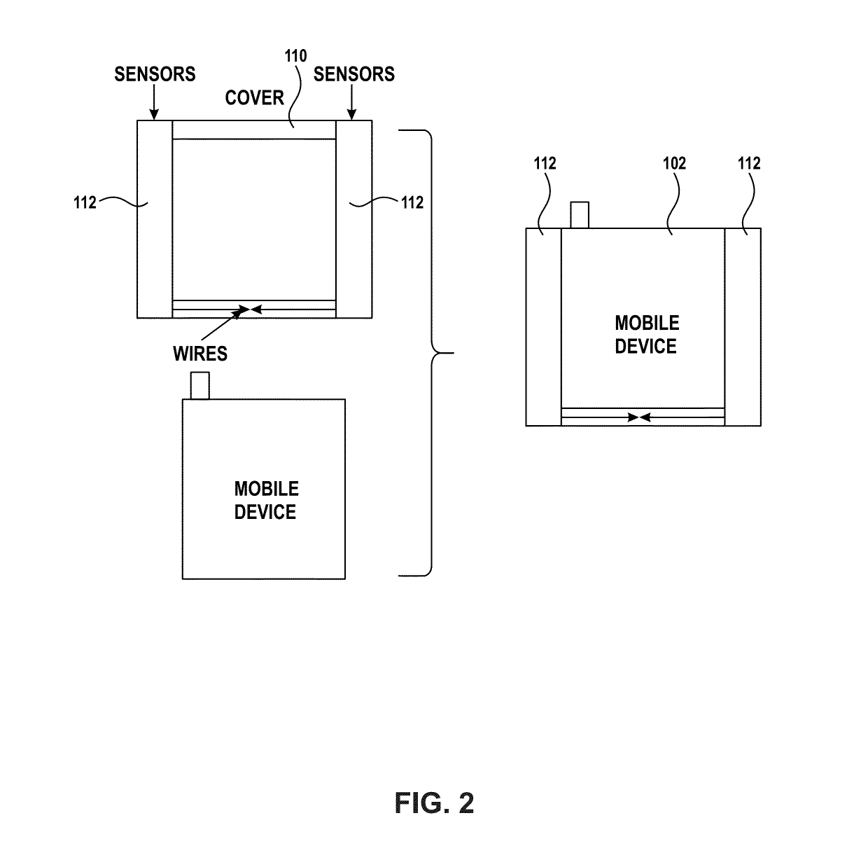

A portable accessory sensing device may also include a device cover 110, such as a screen or body protector where external edges of the cover are comprised of sensors 112. The cover 110, in addition to covering the device 102 for protection and structural support, is comprised of a sensing device 112 that features means to transmit sensing data to the device 102. The cover 110 can be connected to device 102 via electrical pins 108 that will connect to the cell phone's IO port 106. The sensing data can also be connected or input by a wireless protocol. As assembled, the sensing layers on the cover 110 function as an add-in, independent source of input commands to the mobile device to control the functions of the phone. Referring to FIG. 2, the sensing device 112 may cover the entire surface of the front or back screen of the device 102 and be integrated with the sensors covering the lateral edge.

The device cover 110, especially as integrated with the lateral sensors 112, may cover all or a portion of either the front or back face or may be connected between the lateral sensors on either the top or bottom edge, assuming that the orientation maintains access for the IO pin. Referring to FIG. 2, the sensing device 112 may cover the entire surface of the front or back screen of the cell phone and may be integrated with the sensors covering either lateral edge.

The cell phone cover 110, integrated with the lateral sensors may cover all or a potion of either the front or back face or may be connected between the lateral sensors on either the top or bottom edge, assuming that the orientation maintains access for an IO Pin.

### Cell Phone Body

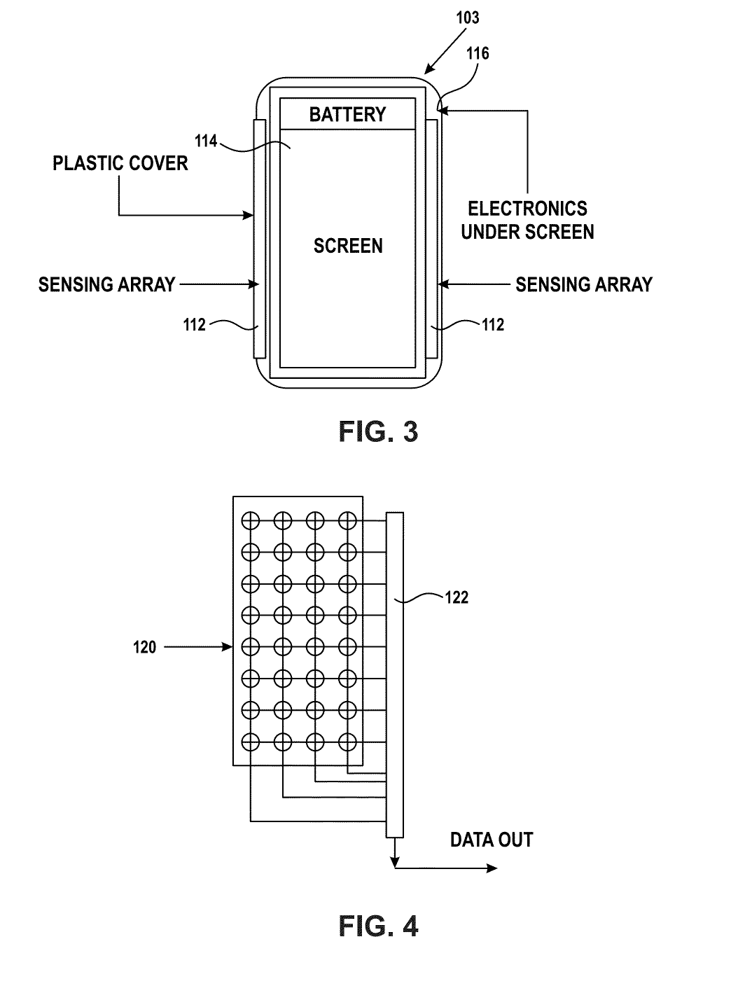

In addition to an add-on structure, the sensing device 112 and functions of the disclosed system and method may be incorporated into the device body. The device body 103, where part or all of its sides 112, backs, top 114, bottom or edges thereof are constructed using sensing material, are used as controllers as described herein. According to FIG. 3, the body of the device 103 contains the sensing device 112, here formed into a sensing array, such that the outer or lateral edges of the device body 103 are comprised of a sensing device that communicates commands to the device 102 to add to the functionality thereof.

### Sensing Device Architecture

A sensing system comprised of array 120 of capacitive or passive resistive materials measures the intensity of the touch of the user and the path of the motion imparted by the user to the phone as it moves in three-dimensional space. This capability will be used to detect and process the natural pressure applied by the grasp of the user and by the movement of the hand alongside the phone, which will be used to transfer the command to phone. The commands may interact with motion or inertial sensing for the phone or may elicit separate commands depending on pre-determined protocols or input from the user or a combination thereof. An example of the structure of a sensing device of the apparatus is shown below having an array of individual interconnected sensors. The array connects to a common cable 122 where it transfers the sensor information to the device 102.

### Driver Software

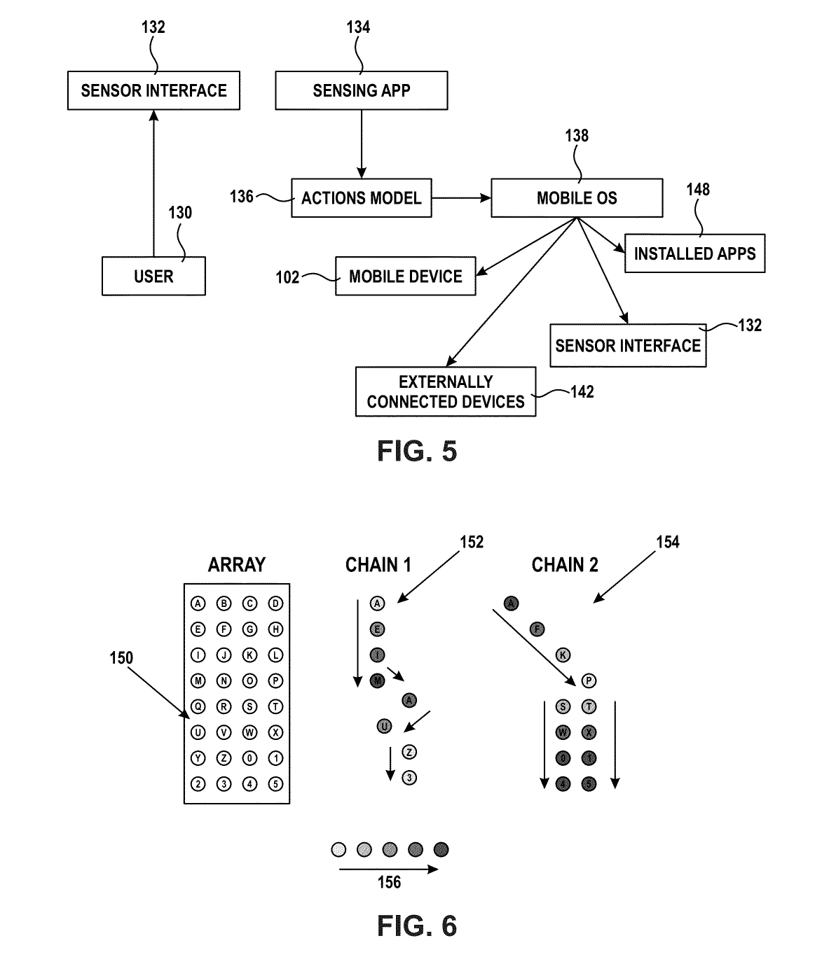

Turning to FIG. 5, A software module may run on a device 102 and receive information through the sensor channels 122, decide whether a particular motion is a command, and make a system call through the device 102 to perform the detected action. The decision making policy is built either using a supervised model through training data or is built online when the system is used for the first time. The driver application 134 on the device 140 will guide each user 130 to perform a set of actions that are necessary to operate the device 102 and its applications. While the user 130 performs the requested actions, the system 100 will record how the action is performed and will map the performance pattern to a particular requested action. When the user 130 touches the sensors 132 in a particular pattern, the software installed 134 and running on the device 102 identifies the movement patterns and looks up the particular pattern in recorded actions modeled in a database, where it has data collected from the calibration phase from the particular user. Then, the module makes a command to the mobile device 102 to perform the specified action, where device 102 performs the action as instructed. The initial call to the mobile operating system OS 138 will have the consequence of interfacing with or activating externally connected devices 142, sensor interfaces 132, installed applications 148 on the phone or the phone. For example, when the user 130 turns on the device 102 for first time (or when it resets the commands), the driver application will ask the user 130 to perform some action that triggers a set of commands that are necessary to operate on the device, such as turn-off/on the phone, increase/decrease the volume, pick-up the phone or perform any other embedded function or user initiated action. The user 130 may also define the selected actions, such as turn the screen to black and white or set of actions, such as “Open the camera and call home”). Each of the performed actions will be mapped to its corresponding request and the result is stored in a private database. In such a case, when the user 130 next activates the device 102, the applied pattern activated a sensing device 132 will be searched on a stored actions/mapping data base. The driving application will initiate the system call mobile OS 138. Mobile OS 138 will send the call to either the app or directly depending on predetermined command the user or a predetermined protocol. Also, the commands can be send to an external device 142 if requested.

### Path Registration

When the user 130 touches or scrolls the hands along the sensing device 132, in the window of a fixed or adjustable time interval, the driver software registers the movement of the touched area of a sensor array 150 and constructs an action chain (152, 154) for each time interval. Action chains (152, 154) are used to recognize a user's intention when touching the sensing as shown in FIG. 6. Each chain is a graph, where nodes in that graph are sensing points and each node in the graph is assigned a weight, which shows the intensity of the touch in that particular sensing point 156 (shading indicates increasing pressure). The chains (152, 154) are used either as pre-determined chains, which are already pre-defined in the system, or can be discrete or individually constructed by user's actions. During operation time, the chains constructed in each time interval are used to find the closest predefined chain to identify the intention of the user 130.

### Chain Matching:

Two chain matching techniques are disclosed. In a first case, if the number of the sensing points are very small and their distance is relatively large then an exact matching algorithm will be used. In this scenario, each sensing point will be marked by a number and an applied pressure will be discretized to a number of discrete values (k). When a particular movement is registered by the system, the constructed chain is converted to a string with a pre-defined convention. Then, the string will be matched exactly with the previously recorded strings of template chains.

In a chain to string conversion, the string is converted with the following convention. Starting from the root node in breadth-first search (BFS) fashion, in traverse order, from left to right add the characters corresponding to recorded pressure points. In graph theory, breadth-first search is a strategy for searching in a graph when search is limited to essentially two operations: (a) visit and inspect a node of a graph; (b) gain access to visit the nodes that neighbor the currently visited node. The BFS begins at a root node and inspects all the neighboring nodes. Then for each of those neighbor nodes in turn, it inspects their neighbor nodes which were unvisited, and so on. If each pressure point Si, has the pressure value of Pi ten in order to present that node in converted String object, the system and method will construct the string representation of the node. For example, pressure point p1 with max pressure value of MP1 will have the string representation as p1MP1, where the pressure point is the prefix of the string representation, while the maximum pressure value is the post fix of the string representation. The concatenation of string representations SRIs will be used for matching similar actions.

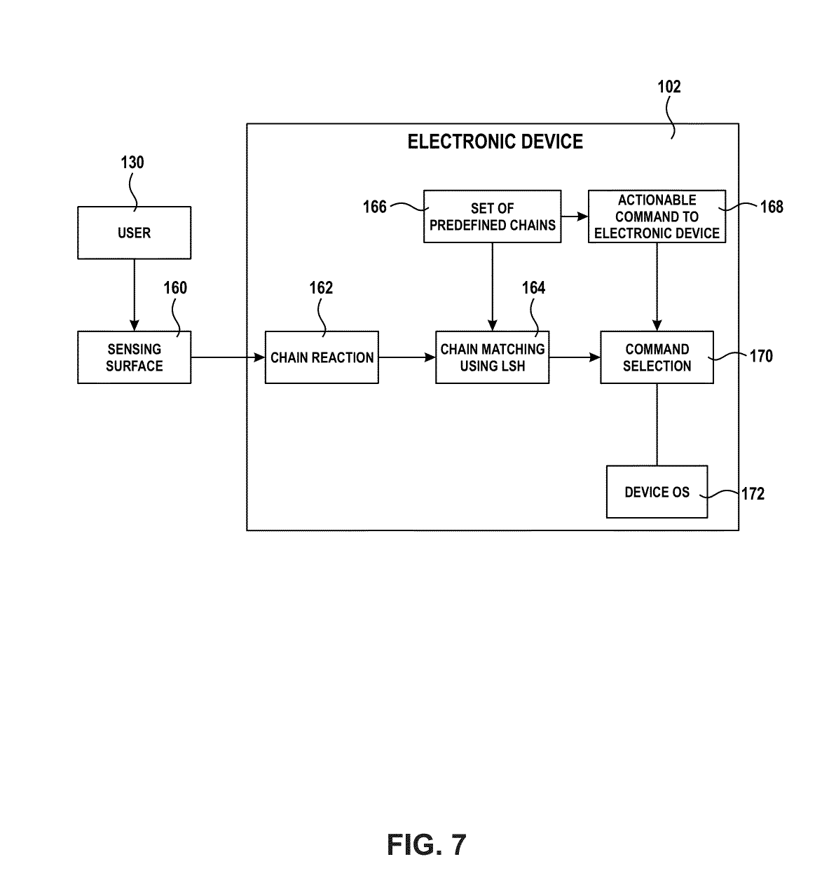

FIG. 7 illustrates a notional embodiment of the chain matching technique. The user 130 makes a physical input on the sensing surface 160. These inputs are detected by the sensors and are sent to the device 102 for interpretation. The chain reaction matching technique 162 constructs an action chain from the input. Next a chain matching algorithm 162 matches the action chain to a set of predefined chains 166. The set of predefined chains 166 is mapped to a discrete set of actionable commands 166 to the device 102. If a chain of a predefined set of chains selected, the system and method will transmit a command 170 to the device's OS 172.

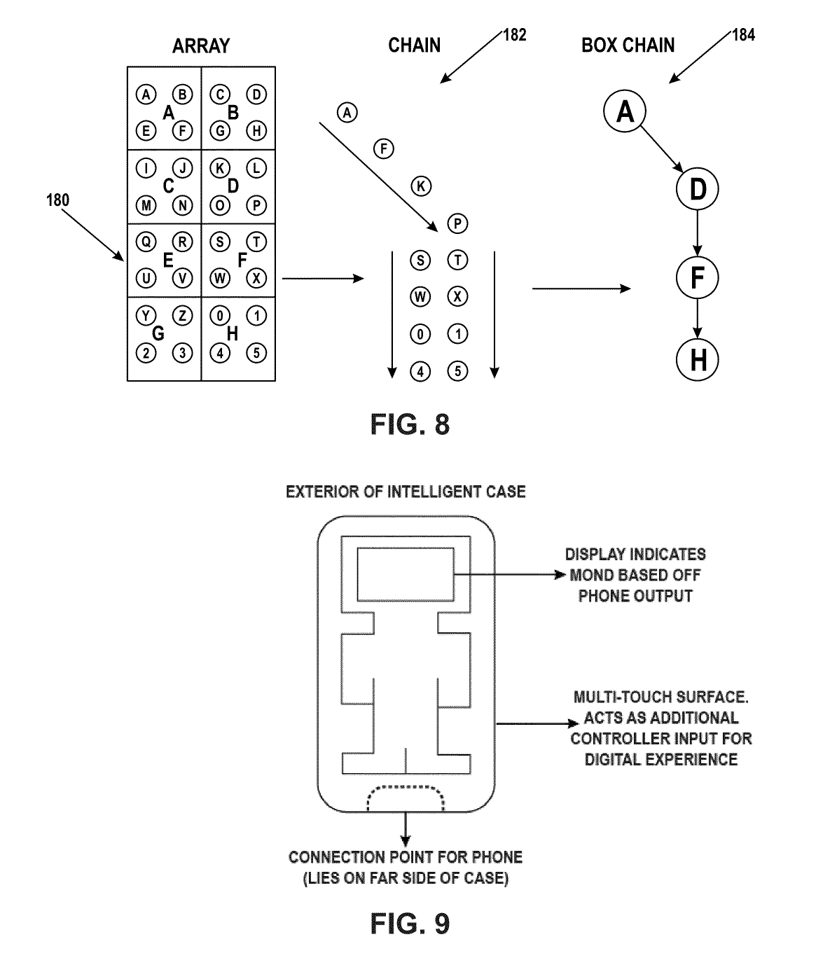

Turning to FIG. 8 which illustrates the second case, if the number of sensing points are small and the sensing points are close together, then a noise reduction technique is applied before constructing the string. Initially a larger grid 180 is considered such that each box in the grid contains a set of pressure sensing points. Then, the transition of the pressure from one box to others is considered. The pressure in each box with the transition to other boxes is considered as a first chain 182 and will a string representation of the chain 183 is constructed using the above specified algorithm.

### Adaptive Path Change:

The software running on the device 102, which is responsible to interpret the activated pressure path and map the pressure point chain to a known command executable by electronic device, can change the path for acceptable chain of triggered pressure for a particular action. This will enforce the user 130 to perform a new pattern for a known action. This is used for both coaching and adaptation. The adjustment can happen by the user's intervention

An example of this is when the regular path is a straight line from top to bottom, which can corresponds to turning-off the wireless internet transmitter/receiver. While performing this action the system might realize that the applied pressure on the top row is gradually decreasing meanwhile the pressure on the adjacent sensor is increasing. In this case, the system will adapt the pattern to the command to turn of the wireless internet transmitter/receiver to the new one.

A) Coaching: In the case when the device is used to perform set of actions for which the progress needs to be promoted and/or verified, a change of pattern will be used to force the users to compute the progress.

B) Adaptation: The patterns can be adapted to a particular user's habit to make the device 102 easily operable for individuals.

### Continuous Sensor Value Acquisition and Interpretation

In addition to measurement of discrete pressure values, the sensing device is capable of measuring continuous pressure values. The user can apply different amounts of pressure at each point on a subset thereof and across the movement path. The sensing system, through its conditioning circuits, is capable of measuring the continuous movement and the amount of the applied pressure on a single point or across the path. The continuous pressure monitoring and its interpretation can be used to translate user intention to a range of actions. For example, an amount of applied pressure can be interpreted and used to adjust the volume of the TV or for audio, hence making the device a controller for TV or audio system.

### Multimode Sensing:

The sensing system can operate in two operational modes. The first mode is the command mode and the second mode is the action mode. In the command mode, the applied pressure on the point/path will be interpreted as an entered command. In the action mode, the applied pressure will be interpreted as the desired action.

### Mode Selection:

A predefined unique action while the sensing devices stay active for a desired interval can be interpreted as a mode changing signal. For example, pressing the top edge of the sensing device and holding it for X seconds can be an example of the mode selection command. Every time that particular action is applied, the sensing device will switch from one mode to another.

### Command Mode:

In command mode, a set of predefined actions is mapped to different external devices and services that are interfaced with the sensing device. For example, if the sensing system is attached to a smartphone and the smartphone features a predefined set of inputs from a companion device, the device can activate commands to pick up the phone, call person X, or communicate with video to adjust TV volume or change a TV channel.

### Action Mode:

In each command mode (ex, call person X or pick up the phone or adjust the volume), a predefined set of actions is used to translate users intention to an actual action in digital domain.

### Applications:

Adjust Audio Volume: The amount of applied pressure will be mapped to the volume, where the minimum and maximum volume are mapped to sensors minimum and maximum calibrated value. The system may also activate itself after the amount of pressure applied to the device reaches a pressure mapping corresponding to a current or preset volume.

Rehabilitation: An example of a rehabilitation application is a remote physiological assessment, where patients are forced to apply the grip on a device with different amount of forces and apply pressure while oscillating its value to follow some certain applied pressure patterns. Based on the assessment derived from input to the sensing device, a rehabilitation protocol or assessment is created and may be communicated to the user for interactive commands or future actions.

SmartPhone text display: Using the phones ring and tone volume controls, scrolling a content while highlighting the text, for example, Applied pressure or positioned adjacent to a sensor superimposed over text may trigger a highlighting feature such that the user's touch above some threshold pressure or duration while scrolling would create a highlighted portion in the specified text.

Game Controller: The continuous values recorded from the sensing system may be as a controller for games that allow such an input. For example, the amount that a steering wheel is turned left or right could be calculated from the location or direction of applied pressure and measured along with the pressure in the specified amplitude as applied on the right or left side of the sensing device.

### Connection:

The sensing device is connected to the phone using wired or wireless connection. In case of wire connection, it can be connected by an s/b=I/O device, such as USB or any proprietary connection on the phone. In case of wireless, the sensing message will be communicated with phone either through low power communication protocol such as Zigbee or via Bluetooth connection.

Output Device with Haptic Capability:

Haptic technology, or haptics, is a tactile feedback technology which takes advantage of the sense of touch by applying forces, vibrations, or motions to the user. This mechanical stimulation can be used to assist in the creation of virtual objects in a computer simulation, to control such virtual objects, and to enhance the remote control of machines and devices (telerobotics). It has been described as “doing for the sense of touch what computer graphics does for vision”. Haptic devices may incorporate tactile sensors that measure forces exerted by the user on the interface.

The above mentioned sensing surface with haptic capability is used to transfer the notifications, messages, or a warning by vibration from the phone or the electronic device to the user. Haptic technologies allows the users to perceive touch sensations generated by the cell phone. The touch sensation is typically created by an actuator embedded in the device and makes the interaction with the cell phone as integrated with the sensing device as described herein, part of an overall system that contains physical and tactile stimulus. The haptic component is provided by an actuator or motor that is controlled by embedded software, which may be integrated with the sensing device described herein, and is integrated into the device via a user interface.

The sensing device integrates the actuator component of the haptic systems electronics to control the haptic system and the overall operation of the cell phone and the sensing device. Control software moderates instructions from the sensing device and the cell phone and generates the input and output signal from the sensing device and provides an output command to the haptic system. The same sensing surface that is used to transfer a command to phone is used to transfer warning, alarms and feedback to users.

### Gaming and Rehab:

The above mentioned sensing surface attaches to a gaming platform controller or itself acts a as gaming platform controller. It is also used in rehabilitation devices to control neurological monitoring systems, assess fitness, or quantify the patient's progress. In addition, the haptic capability can be used to promote the exercise in the context of a game.

The sensing device can also be in form of a matt or embedded in carpet, or in bed sheet. The user's feet operate on a device that is connected to the sensing matt. For example, such a mat can be on hospital bed on patients leg section or it can be part of the carpet that people put under their feet or part of the wheelchair that supports the feet. In this scenario, the movement and applied pressure by feet will be used to command performance of different actions. Movement of both feet will be registered and will be used to construct chains. Then, the chains are matched with a predefined chain to find the corresponding action and the action will be performed.

Referring to FIG. 9, the device can take on the form of an intelligent case/jacket that interfaces with a digital device such as a mobile phone or tablet. The ‘case’ connects to the digital device and acts as a sensor/display/controller. An app can be loaded on the digital device. The ‘case’ can then provide a variety of inputs and also receive output from the digital device.

For example, the case connects to the phone and can be designed to look like a robot. An app is loaded (in this example a pet management game) and the robot case provides specific input (beyond that of the phone) e.g. multi touch surface—enhancing the digital experience. The phone can also transmit data to a display which is housed on the actual case and for example can provide a means for the user to gauge the happiness of the robot.

Capacitive sensors are constructed from many different media, such as copper, Indium tin oxide (ITO) and printed ink. Copper capacitive sensors can be implemented on standard FR4 PCBs as well as on flexible material. ITO allows the capacitive sensor to be up to 90% transparent (for one layer solutions, such as touch phone screens). Size and spacing of the capacitive sensor are both very important to the sensor's performance. In addition to the size of the sensor, and its spacing relative to the ground plane, the type of ground plane used is very important. Since the parasitic capacitance of the sensor is related to the electric field's path to ground, it is important to choose a ground plane that limits the concentration of e-field lines with no conductive object present.

Designing a capacitance sensing system requires first picking the type of sensing material (FR4, Flex, ITO, etc.). One also needs to understand the environment the device will operate in, such as the full operating temperature range, what radio frequencies are present and how the user will interact with the interface.

There are two types of capacitive sensing system: mutual capacitance, where the object (finger, conductive stylus) alters the mutual coupling between row and column electrodes, which are scanned sequentially, and self- or absolute capacitance where the object (such as a finger) loads the sensor or increases the parasitic capacitance to ground. In both cases, the difference of a preceding absolute position from the present absolute position yields the relative motion of the object or finger during that time.

Surface capacitance: In this basic technology, only one side of the insulator is coated with conductive material. A small voltage is applied to this layer, resulting in a uniform electrostatic field. When a conductor, such as a human finger, touches the uncoated surface, a capacitor is dynamically formed. Because of the sheet resistance of the surface, each corner is measured to have a different effective capacitance. The sensor's controller can determine the location of the touch indirectly from the change in the capacitance as measured from the four corners of the panel: the larger the change in capacitance, the closer the touch is to that corner. With no moving parts, it is moderately durable, but has low resolution, is prone to false signals from parasitic capacitive coupling, and needs calibration during manufacture.

Projected capacitive touch (PCT) technology is a capacitive technology which allows more accurate and flexible operation, by etching the conductive layer. An X-Y grid is formed either by etching one layer to form a grid pattern of electrodes, or by etching two separate, perpendicular layers of conductive material with parallel lines or tracks to form the grid; comparable to the pixel grid found in many liquid crystal displays (LCD).

The greater resolution of PCT allows operation with no direct contact, such that the conducting layers can be coated with further protective insulating layers, and operate even under screen protectors, or behind weather and vandal-proof glass. Because the top layer of a PCT is glass, PCT is a more robust solution versus resistive touch technology. Depending on the implementation, an active or passive stylus can be used instead of or in addition to a finger. This is common with point of sale devices that require signature capture. Gloved fingers may or may not be sensed, depending on the implementation and gain settings. Conductive smudges and similar interference on the panel surface can interfere with the performance. Such conductive smudges come mostly from sticky or sweaty finger tips, especially in high humidity environments. Collected dust, which adheres to the screen because of moisture from fingertips can also be a problem.

There are two types of PCT: self capacitance, and mutual capacitance.

Mutual capacitive sensors have a capacitor at each intersection of each row and each column. A 12-by-16 array, for example, would have 192 independent capacitors. A voltage is applied to the rows or columns. Bringing a finger or conductive stylus near the surface of the sensor changes the local electric field which reduces the mutual capacitance. The capacitance change at every individual point on the grid can be measured to accurately determine the touch location by measuring the voltage in the other axis. Mutual capacitance allows multi-touch operation where multiple fingers, palms or styli can be accurately tracked at the same time.

Self-capacitance sensors can have the same X-Y grid as mutual capacitance sensors, but the columns and rows operate independently. With self-capacitance, current senses the capacitive load of a finger on each column or row. This produces a stronger signal than mutual capacitance sensing, but it is unable to resolve accurately more than one finger, which results in “ghosting”, or misplaced location sensing.

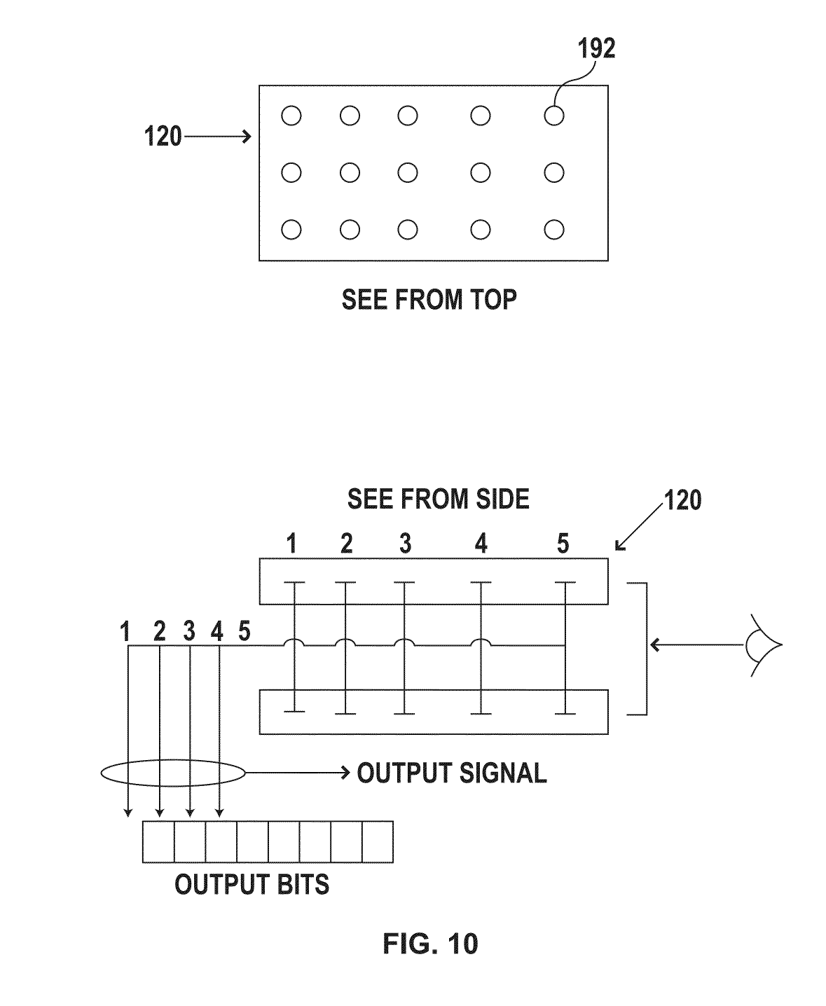

FIG. 10 illustrates the top and side views of an exemplary pressure sensor array. The presently disclosed pressure sensors differ from the previously described sensors because the output value per sensor is not binary (zero or one), but it has a range between X and Y. So instead of saying that the sensor is activated or not the sensor will measure if the sensor is pushed by pressure amount X, where X is between 0 and Y. This way we can say how much pressure is applied.

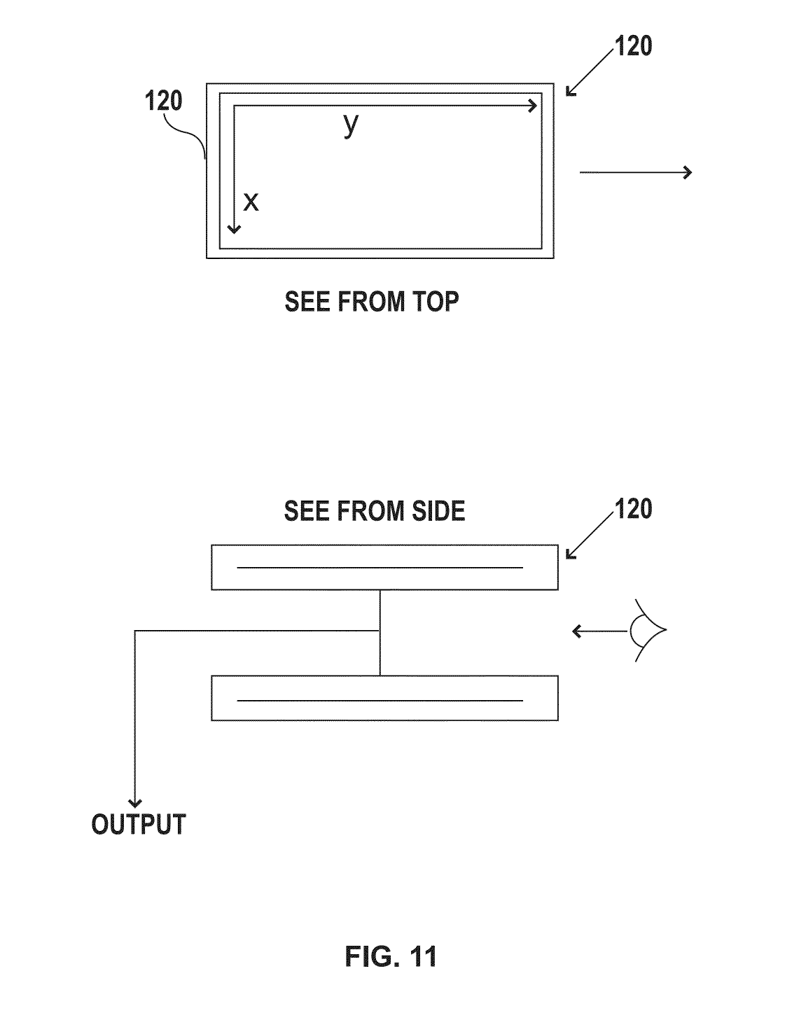

Turning to FIG. 11, is a further illustration of a top and side view of an exemplary pressure sensor which is not comprised of an array of sensors. For this of sensing the output value X is between 0 and Y. By examining the value we will be able to decode where the pressure is applied and how much pressure is applied. This case we will not have exact point but it will be an approximate location and amount of pressure which is sufficient. In this embodiment, the output is a function of location pressure and amount. Output=f (x,y,p) where p is the pressure measurement.

The disclosed embodiments are susceptible to various modifications and alternative forms, and specific examples thereof have been shown by way of example in the drawings and herein described in detail. It should be understood, however, that the disclosed embodiments are not meant to be limited to the particular forms or methods disclosed, but to the contrary, the disclosed embodiments are to cover all modifications, equivalents, and alternatives.

What is claimed is:

1. A pressuring sensing apparatus, comprising:
an array of pressure sensors communicably connected to a portable electronic device.

2. The apparatus of claim 1, wherein the sensor array is physically affixed to a cover of the device.

3. The apparatus of claim 1, wherein the sensor array is physically affixed to a body of the device.

4. The apparatus of claim 1, further comprising wherein said sensors function as an additional, independent source of input commands to the portable device.

5. The apparatus of claim 1, further comprising wherein said sensors are incorporated on a left side and a right side of a face of the portable electronic device.

6. The apparatus of claim 1, further comprising wherein said sensors comprise a plurality of capacitance type sensors.

7. The apparatus of claim 1, further comprising wherein said sensors comprise a plurality of passive resistance type sensors.

8. The apparatus of claim 1, further comprising wherein the sensors communicate with the portable electronic device through a plurality of input-output pins.

9. The apparatus of claim 1, further comprising wherein the sensors communicate with the portable electronic device through a proprietary wireless communication protocol.

10. The apparatus of claim 1, further comprising wherein the portable electronic device is a smart phone.

11. The apparatus of claim 1, further comprising wherein the portable electronic device is a device controller.

12. The apparatus of claim 2, further comprising wherein the sensors cover all or a portion of either a front or a back face of the cover.

13. The apparatus of claim 11, further comprising an incorporated haptic capability, which is used for rehabilitation by asking users to apply pressure on a surface of the device that vibrates.

14. A method of sensor interpretation, comprising:
registering a user's touch on a sensor array,
constructing an action chain based on sensor activation during a preset time interval,
correlating the action chain to a predetermined chain.

15. The method of claim 14, further comprising wherein the predetermined chain comprises a predefined chain.

16. The method of claim 14, further comprising wherein the predetermined chain comprises a learned chain from a previous user action.

17. The method of claim 14, further comprising wherein the predetermined chain is interpreted as a system command.

18. The method of sensor interpretation of claim 14, further comprising:
applying a noise reduction technique on the sensor inputs prior to construct of the action chain.

19. The method of claim 18, further comprising wherein the noise reduction technique comprises:
constructing a theoretical grid such that each box in the grid contains a set of pressure sensing points,
registering a transition of a pressure from one box in the grid to another box in the grid,
using the pressure in each box and the transition to other boxes to construct a first string representation.

20. An pressure sensing apparatus, comprising:
An array of pressure sensors incorporated into a body of a bed, a wheelchair or rehabilitation device, wherein the pressure sensors act as an input to a controller.
